(19) United States
(12) Patent Application Publication
(10) Pub. No.: US 2004/0220896 A1
(43) Pub. Date: Nov. 4, 2004

(54) System and method for optimizing queries on views defined by conditional expressions having mutually exclusive conditions

(75) Inventors: Ian Richard Finlay, Uxbridge (CA); Calisto Paul Zuzarte, Pickering (CA)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/427,311

(22) Filed: Apr. 30, 2003

(51) Int. Cl. G06F 17/30

(52) U.S. Cl. 707/1

(57) ABSTRACT

A query rewrite optimization method eliminates condition predicates of conditional expressions defining the values of a column that is referenced in the predicate of an SQL query on a view. The method evaluates the query to identify a view and a predicate referencing a column of the view. The column has values selected by a conditional expression having condition predicates defining respective mutually exclusive ranges of values. The predicate defines a first range of values. A determination is made as to whether one of the condition predicates defines a mutually exclusive range of values that comprises the first range of values. In response, the query is rewritten to eliminate the condition predicates other than the one condition predicate. The predicate is thus applied directly to the base tables without evaluating the conditional expression.

### FIELD OF THE INVENTION

This invention relates generally to information retrieval systems and, more particularly, to information retrieval systems for optimizing queries on views defined by conditional expressions.

### BACKGROUND OF THE INVENTION

One popular form of an information retrieval system for managing computerized records is a relational database management system, such as DB2™ manufactured by IBM™. Between the actual database (i.e. the data as stored for use by a computer) and the users of the database is a software layer known as the relational database management system (“RDBMS” or “DBMS”). The DBMS is responsible for handling all requests for access to the database, shielding the users from the details of any specific hardware implementation. Using relational techniques, the DBMS stores, manipulates and retrieves data in the form of table-like relations typically defined by a set of columns or attributes of data types and a set of rows (i.e. records or tuples) of data. The columns may further comprise restrictions on their data content (i.e. valid domains) and may be designated as a primary key or unique identifier for the relation or a foreign key for one or more other relations.

The standard language for dealing with DBMSs is the Structured Query Language (“SQL”). SQL comprises both data definition operations and data manipulation operations. To maintain data independence a query (i.e. a set of SQL commands) instructs the DBMS what to do but not how to do it. Thus, the DBMS comprises a query processor for generating various query plans of execution and choosing the least expensive plan with respect to execution costs. Due to the high-level nature of relational expressions and a variety of implementation techniques, automatic query optimization is possible and often necessary to ensure more efficient query processing.

In accordance with well-known query translation processes, an SQL query is processed in stages. For example, an initial stage may cast the source query into an internal form or model, such as a Query Graph Model (“QGM”), following the preliminary steps of lexing, parsing and semantic checking. The goal of this model is to provide a more manageable representation of queries to reduce the complexity of query compilation and optimization. The internal model is a data structure for providing the semantic relationships of the query for use by query translator and optimizer components for rewriting the query in a canonical form. In a next phase, a plan optimizer produces a query execution plan such as by generating alternate plans and choosing a best plan based on estimated execution costs. A plan refinement stage may be employed to refine the optimum execution plan in accordance with run-time requirements. The query optimizer may use techniques such as subsumption, redundant join elimination, etc.

Often, a database application may require the creation of a “view” for the data in given relations or tables. A view provides an alternative way of looking at the data in one or more base tables. It may, for example, contain only selected columns from the table. In workgroup applications such as Team Connect™, for example, column level security may be implemented with complex views that restrict users from selected base table columns for which they do not have security clearance. In fact, the use of column level security views is increasing in popularity as new applications call for access to organizational databases by both internal and external users. In such complex applications, the creation of the view or selections of data from the view may involve the processing of multiple “CASE” expressions.

CASE expressions allow an expression to be selected based on the evaluation of one or more conditions. In general, the value of the CASE expression is the value of the result-expression following the first (leftmost) case that evaluates to true. If no case evaluates to true and the ELSE keyword is present then the result is the value of the result-expression. If no case evaluates to true and the ELSE keyword is not present then the result is NULL. In addition, when a case evaluates to unknown (because of NULLs), the case is not true and hence is treated the same way as a case that evaluates to false.

Consider the following typical example of the use of a CASE expression in the creation of a view:

| CREATE TABLE T1(C1 INT, C2 INT, C3 INT) S1 | |
|---|---|
| CREATE VIEW V1(X1, X2) AS S2 | |
| (SELECT( CASE | WHEN C1 < C2 THEN “NEGATIVE” |
| | WHEN C1 > C2 THEN “POSITIVE” |
| | WHEN C1 = C2 THEN “EQUAL” |
| | END), |

C3 FROM T1 WHERE C3 <> C1+C2)
SELECT * FROM V1 WHERE X1 = “EQUAL” S3

In the above example, the SQL CREATE TABLE statement, S1, is used to create a base table T1 having three integer-valued columns C1, C2, and C3. The CREATE VIEW statement, S2, is used to create a view or named result table V1 having two columns X1 and X2 the contents of which are derived from the columns of table T1 with a sub-query containing a CASE expression. Given the condition that C3 is not equal to the sum of C1 and C2, the X1 column of view V1 is populated by the CASE expression with the data “NEGATIVE”, “POSITIVE”, or “EQUAL” while the X2 column is populated with data from column C3. The SELECT * query, S3, then returns a result table that comprises the rows of columns X1 and X2 of view V1 where the value of column X1 is “EQUAL”. The condition X1=“EQUAL” is referred to as a predicate. In general, a predicate specifies a condition that is true, false, or unknown about a given row.

One disadvantage of present optimization methods is their inefficiency in optimizing queries on views defined by such CASE expressions. To process the SELECT query, S3, in the above example, a current DBMS typically evaluates the CASE expression prior to applying the predicate in the SELECT query to the resulting view. This is often a computationally expensive operation.

A need therefore exists for an improved system and associated method of optimizing SQL queries on views the columns of which are defined by statements containing CASE expressions. Accordingly, a solution that addresses, at least in part, the above and other shortcomings is desired. The need for such system and method has heretofore remained unsatisfied.

### SUMMARY OF THE INVENTION

The present invention satisfies this need, and presents a system, a computer program product, and an associated method (collectively referred to herein as “the system” or “the present system”) for providing, for an information retrieval system, a query rewrite optimization method. This query rewrite optimization method eliminates condition predicates of conditional expressions defining the values of a column that is referenced in the predicate of an SQL query on a view. The method evaluates the query to identify a view and a predicate referencing a column of the view. The column has values selected by a conditional expression having condition predicates defining respective mutually exclusive ranges of values. The predicate defines a first range of values. A determination is then made as to whether one of the condition predicates defines a mutually exclusive range of values that comprises the first range of values. In response to these steps of evaluating and determining, the query is rewritten to eliminate the condition predicates other than the one condition predicate. The predicate is thus applied directly to the base tables without evaluating the conditional expression.

Preferably, the conditional expression is a CASE expression or an IF THEN ELSE expression, the view is over one or more base tables, and the view is a security view restricting users from viewing selected columns of the base tables.

In accordance with an aspect of the present system, there is provided, for an information retrieval system, a method for optimizing a query. This method comprises evaluating the query to identify a view and a predicate referencing a column of the view. The view is derived from one or more base tables. The column has values selected by a conditional expression having condition predicates defining respective mutually exclusive ranges of the values. The condition predicates reference one or more base columns of the base tables. The predicate defines a first range of the values of the column. The method also comprises determining whether one of the condition predicates defines a mutually exclusive range of the values that comprises the first range of the values. In addition, the method comprises rewriting the query to eliminate the condition predicates other than the one of the condition predicates and to apply the predicate directly to the base tables without evaluating the conditional expression.

In accordance with another aspect of the present system, there is provided, for an information retrieval system, a query optimizer system for optimizing a query. The query optimizer system comprises a query evaluator for the query to (a) identify a view and a predicate referencing a column of the view, the view derived from one or more base tables, the column having values selected by a conditional expression having condition predicates defining respective mutually exclusive ranges of the values, the condition predicates referencing one or more base columns of the base tables, the predicate defining a first range of the values of the column, and, (b) determine whether one of the condition predicates defines a mutually exclusive range of the values that comprises the first range of the values, and, a query rewriter for the query to rewrite the query to eliminate the condition predicates other than the one of the condition predicates and to apply the predicate directly to the base tables without evaluating the conditional expression in response to the query evaluator.

In accordance with yet another aspect of the present system, there is provided a computer program product having a computer readable medium tangibly embodying computer executable code for directing an information retrieval system to optimize a query. The computer program product comprises code for evaluating the query to identify a view and a predicate referencing a column of the view, the view derived from one or more base tables, the column having values selected by a conditional expression having condition predicates defining respective mutually exclusive ranges of the values, the condition predicates referencing one or more base columns of the base tables, the predicate defining a first range of the values of the column, code for determining whether one of the condition predicates defines a mutually exclusive range of the values that comprises the first range of the values, and, code for rewriting the query to eliminate the condition predicates other than the one of the condition predicates and to apply the predicate directly to the base tables without evaluating the conditional expression.

In accordance with yet another aspect of the present system, there is provided an article having a computer readable modulated carrier signal being usable over a network, and having means embedded in the computer readable modulated carrier signal for directing an information retrieval system to optimize a query. The article comprises means in the medium for evaluating the query to identify a view and a predicate referencing a column of the view, the view derived from one or more base tables, the column having values selected by a conditional expression having condition predicates defining respective mutually exclusive ranges of the values, the condition predicates referencing one or more base columns of the base tables, the predicate defining a first range of the values of the column, means in the medium for determining whether one of the condition predicates defines a mutually exclusive range of the values that comprises the first range of the values, and, means in the medium for rewriting the query to eliminate the condition predicates other than the one of the condition predicates and to apply the predicate directly to the base tables without evaluating the conditional expression.

Advantageously, the present system allows predicates that would otherwise be lost as primary filters to be applied directly to a base table. This improves query performance.

In accordance with yet another aspect of the present system, there is provided, for an information retrieval system, a method for optimizing a query, comprising evaluating the query to identify a view and a predicate referencing a column of the view, the view derived from one or more base tables, the column having values selected by a conditional expression having condition predicates defining respective mutually exclusive ranges of the values, the condition predicates referencing one or more base columns of the base tables, and, the predicate defining a first range of the values of the column.

In accordance with yet another aspect of the present system, there is provided an information retrieval system for optimizing a query, comprising means for evaluating the query to identify a view and a predicate referencing a column of the view, the view derived from one or more base tables, the column having values selected by a conditional expression having condition predicates defining respective mutually exclusive ranges of the values, the condition predicates referencing one or more base columns of the base tables, and, the predicate defining a first range of the values of the column.

In accordance with yet another aspect of the present system, there is provided a computer program product having a computer readable medium tangibly embodying computer executable code for directing an information retrieval system to optimize a query, the computer program product comprising code for evaluating the query to identify a view and a predicate referencing a column of the view, the view derived from one or more base tables, the column having values selected by a conditional expression having condition predicates defining respective mutually exclusive ranges of the values, the condition predicates referencing one or more base columns of the base tables, and, the predicate defining a first range of the values of the column.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a block diagram illustrating an exemplary data processing system for implementing an embodiment of the invention;

FIG. 2 is a flow chart illustrating the operations of a query optimization process in accordance with an embodiment of the invention; and,

FIG. 3 is a flow chart illustrating the operations of a query optimization process for optimizing a query on a view defined by a conditional expression in accordance with an embodiment of the invention.

### DETAILED DESCRIPTION OF PREFERRED EMBODIMENTS

The following detailed description of the embodiments of the present invention does not limit the implementation of the invention to any particular computer programming language. The present invention may be implemented in any computer programming language provided that the OS (Operating System) provides the facilities that may support the requirements of the present invention. An embodiment is implemented in the C or C++ computer programming language (or other computer programming languages in conjunction with C/C++). Any limitations presented would be a result of a particular type of operating system, computer programming language, or data processing system, and would not be a limitation of the present invention.

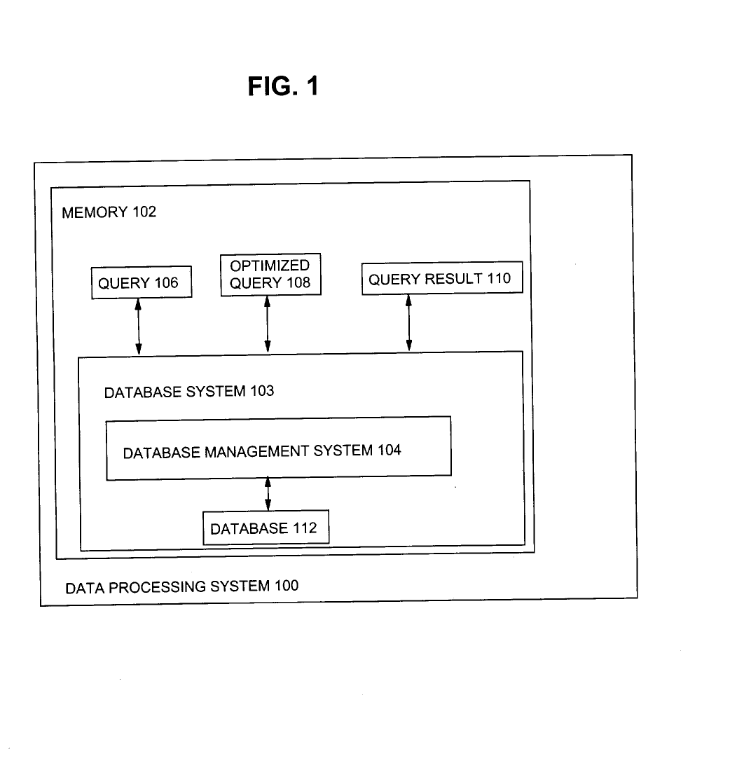

FIG. 1 shows a database system 103 that comprises an information retrieval system such as a database management system (DBMS) 104 and a database 112. The database system 103 is stored in the memory 102 of a data processing system 100. It may be appreciated that the database system 103 may be shipped or installed without the database 112 to or by end users. In general, the DBMS 104 reads a query 106 provided by a user (via keyboard entry and the like). The DBMS 104 then executes the query 106 against the database 112 and provides a query result 110 to the user. However, to improve query performance, the DBMS 104 is adapted by the present invention to transform the query 106 using a query optimization process into an optimized query 108, which the DBMS 104 then executes or applies against the database 112 to generate the query result 110.

It may be appreciated that the database system 103 may be stored in the memory 102 of the data processing system 100 or stored in a distributed data processing system (not depicted). The data processing system 100 comprises a central processing unit (“CPU”) (not depicted) operatively coupled to memory 102 that also stores an operating system (not depicted) for general management of the data processing system 100. An example of a suitable data processing system 100 is the IBM™ ThinkPad™ computer. The database system 103 comprises computer executable programmed instructions for directing the data processing system 100 to implement the embodiments of the present invention. The programmed instructions may be embodied on a computer readable medium (such as a CD disk or floppy disk) that may be used for transporting the programmed instructions to the memory 102 of data processing system 100. Alternatively, the programmed instructions may be embedded in a computer-readable, signal-bearing medium that is uploaded to a network by a vendor or supplier of the programmed instructions, and this signal-bearing medium may be downloaded to the data processing system 100 from the network (not depicted) by end users or potential buyers.

The CPU of the data processing system 100 is typically coupled to one or more devices (not depicted) for receiving user queries and for displaying the results of the queries. User queries typically comprise a combination of SQL commands for producing one or more tables of output data. The CPU is coupled to memory 102 for containing programs such as DBMS 104 and data in database 112 such as base tables or virtual tables such as views or derived tables (i.e. tables determined from one or more base tables according to CREATE VIEW or other statements). The memory 102 may comprise a variety of storage devices comprising internal memory and external mass storage typically arranged in a hierarchy of storage as understood to those skilled in the art.

The database system 103 comprises a control program for managing the components of the database system 103. The components comprise a component for receiving a query 106 from a user and a component for processing the query 106 typically in accordance with a query optimization process that may comprise a query model (e.g. QGM). Additional components perform query plan determination comprising generating, costing and selecting a plan as well as eventual plan execution.

In general, the query optimization process of the database system 103 comprises an optimizer module, a code generation optimizer module, and a runtime system (interpreter) module. The optimizer module reads the original query 106 and then generates an optimizer plan representing the optimized query 108. The code generation optimizer module reads the optimizer plan and generates an access plan. The runtime system (interpreter) module reads the access plan and subsequently generates the query result 110.

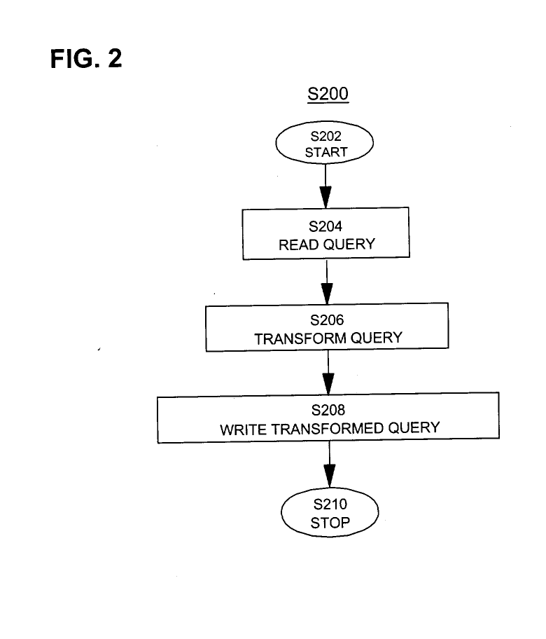

FIG. 2 is a flow chart illustrating the operations S200 of a query optimization process in accordance with an embodiment of the invention. At step S202, the operations S200 start. At step S204, a query 106 is read. At steps S206 and S208, the query 106 is transformed and rewritten into an optimized query 108. At step S210, the operations end.

Consider again the above example of the use of a CASE expression in the creation of a view and a query relating to that view:

| CREATE TABLE T1(C1 INT, C2 INT, C3 INT) S4 | |
|---|---|
| CREATE VIEW V1(X1, X2) AS S5 | |
| (SELECT( CASE | WHEN C1 < C2 THEN “NEGATIVE” |
| | WHEN C1 > C2 THEN “POSITIVE” |
| | WHEN C1 = C2 THEN “EQUAL” |
| | END), |

C3 FROM T1 WHERE C3 <> C1+C2)
SELECT * FROM V1 WHERE X1 = “EQUAL” S6

The SELECT * query, S6, in the above example may be considered as an original query 106. The goal of the query optimization process is to transform this original query 106 into an optimized query 108 to improve processing efficiency. An analysis of the above query 106 indicates that an optimization is possible that could indeed save significant processing cost. For example, expanding using CASE expression terms from the CREATE VIEW statement, S5, the SELECT * query, S6, may be rewritten as follows:

| | |
|---|---|
| SELECT (CASE | WHEN C1 < C2 THEN “NEGATIVE” S7 |
| | WHEN C1 > C2 THEN “POSITIVE” |
| | WHEN C1 = C2 THEN “EQUAL” |
| | END), C3 FROM T1 WHERE C3 <> C1+C2) |

AND WHERE(CASE WHEN C1 < C2 THEN “NEGATIVE”

WHEN C1 > C2 THEN “POSITIVE”
WHEN C1 = C2 THEN “EQUAL”
END) = “EQUAL”

This rewriting may be considered a form of view merging in which the SELECT * query, S6, is unfolded by incorporation of the elements defining the view V1, from S5, comprising the CASE expression. This query may be further rewritten as the following optimized query 108:

SELECT “EQUAL”, C3 FROM T1 S8
WHERE C3 <> C1+C2 AND C1 = C2

To perform this transformation, the query optimization process tests for predicates in the CASE expression of the CREATE VIEW statement, S5, or merged SELECT query, S7, that are mutually exclusive. In the above example, the predicates C1<C2, C1>C2, and C1=C2 are mutually exclusive. The query optimization process then tests for a predicate in the SELECT query, S6, that matches (i.e. comprises or subsumes) the return value for one of the mutually exclusive predicates of the CASE expression. In the above example, the SELECT query, S6, WHERE clause predicate X1=“EQUAL” matches the CASE expression WHEN clause predicate return value for WHEN condition C1=C2 that defines the column X1 in the CREATE VIEW statement, S5, or merged SELECT query, S7. If both tests are passed, as in the above example, the SELECT query may be optimized by, having merged the CASE expression from the CREATE VIEW statement into the query, using the matched predicate (i.e. C1=C2) to remove remaining mutually exclusive CASE expression predicates.

Following this method, the query optimization process optimizes the original query 106 on a view defined using CASE expressions. Advantageously, the matched predicate (i.e. C1=C2) is not lost as a filter due to the CREATE VIEW statement, S5, but may be applied directly to the base table T1. With this method a simple predicate may be applied to the base table rather than a more complex predicate (i.e. “EQUAL”=(CASE WHEN C1<C2 THEN “NEGATIVE” WHEN C1>C2 THEN “POSITIVE” WHEN C1=C2 THEN “EQUAL” END)).

As mentioned above, in workgroup applications such as Team Connect™, column-level security may be implemented with complex views that restrict users from selected base table columns for which they do not have security clearance. In these applications, a security view typically returns either a column from a base table, or NULL, if the user does not have authority to view the underlying data contained in the base table. In such complex applications, the creation of the view or selections of data from the view may involve the processing of multiple CASE expressions.

Consider the following example SQL statements typical of a security view application. In these statements, a first base table SECURITY is created with a first CREATE TABLE statement, S9. An index I1 is created on the USER_ID column of the SECURITY table with a CREATE UNIQUE INDEX statement, S10. A second base table ACCOUNT is created with a second CREATE TABLE statement, S11. A security view SECURE_ACCOUNT is created with a CREATE VIEW statement, S12, containing CASE expressions.

```
CREATE TABLE SECURITY S9
  (USER_ID VARCHAR(30), AUTHORITY INT, SECURE_GROUP
  CHAR(1), DEV_GROUP CHAR(1))
CREATE UNIQUE INDEX I1 ON SECURITY (USER_ID) S10
CREATE TABLE ACCOUNT S11
  (ACCT_NO INT, REQ_AUTHORITY INT, OWNER
  VARCHAR(100), BALANCE DECIMAL(20,2) NOT NULL)
CREATE VIEW SECURE_ACCOUNT (ACCT_NO, OWNER,
BALANCE) S12
  AS (SELECT ACCT_NO, OWNER,
    (CASE WHEN AUTHORITY > REQ_AUTHORITY THEN
    BALANCE
      ELSE NULL
      END)
  FROM SECURITY, ACCOUNT WHERE USER_ID = USER)
```

Here, the base table SECURITY comprises a character-valued column USER_ID for storing user identification strings. In addition, the base table SECURITY comprises an integer-valued column AUTHORITY for storing an authority level identifier, a character-valued column SECURE_GROUP for storing a group security identifier, and a character-valued column DEV_GROUP for storing a development group identifier. The index I1 is created on the column USER_ID. The base table SECURITY is thus used for storing security access related information for users of the DBMS.

The base table ACCOUNT on the other hand is for storing bank or credit card account balance data information for account owners tracked by the DBMS. The ACCOUNT table comprises integer-valued column ACCT_NO for storing the account number of the account. The ACCOUNT table also comprises integer-valued column REQ_AUTHORITY for storing a required authority level identifier for gaining access to account information, character-valued column OWNER for storing account owner identification information, and decimal-valued column BALANCE for storing the amount in the owner's account. The CREATE TABLE ACCOUNT statement, S11, comprises the column option NOT NULL for the column BALANCE. In general, a column option in a CREATE TABLE statement defines additional options related to columns of the table. The column option NOT NULL prevents the column from containing null values.

The view SECURE_ACCOUNT contains selected rows of columns ACCT_NO, OWNER, and BALANCE from the base tables SECURITY and ACCOUNT. The rows of the view table are selected by a sub-query in accordance with the CASE expression and WHERE clause contained in the CREATE VIEW statement as follows. Given the variable USER that may be entered by a user of the DBMS 104, the DBMS compares the value of USER to the values stored in the USER_ID column of the SECURITY table and selects a matching row or rows. This is the function of the WHERE clause with its USER_ID=USER predicate. The matched row may contain a value in the AUTHORITY column designating the authority level of the user. Using this authority level, the DBMS then populates the BALANCE column of the SECURE_ACCOUNT table with either balance information from the BALANCE column of the base table ACCOUNT or NULL. The view SECURE_ACCOUNT may contain a non-NULL BALANCE column only if the authority level of the user is greater than the required authority necessary to view the balance information as specified in the REQ_AUTHORITY column of the base table ACCOUNT. Thus, and is typical of security views in groupware applications, the view SECURE_ACCOUNT, S12, “nulls out” balance information that a user is not authorized to see.

Now consider the following query applied to the above SECURE_ACCOUNT view:

```
SELECT ACCT_NO, OWNER, BALANCE S13
    FROM SECURE_ACCOUNT
    WHERE BALANCE > 100,000
```

This query selects those rows from the view SECURE_ACCOUNT having a balance value from the BALANCE column of greater than 100,000. The WHERE clause predicate BALANCE>100,000 is with respect to the column BALANCE, the content of which was modified by the CASE expression in the view defining CREATE VIEW statement.

To optimize this query, the query optimization process rewrites the query to express the view table SECURE_ACCOUNT, S12, in terms of base tables SECURITY and ACCOUNT, hence introducing the CASE expression and WHERE clause from the CREATE VIEW statement, S12. In other words, the query optimization process unfolds the SELECT query by incorporation of the CASE expression and WHERE clause elements defining the SECURE_ACCOUNT view, S12, as follows:

```
SELECT ACCT_NO, OWNER, S14
    (CASE WHEN AUTHORITY > REQ_AUTHORITY
    THEN BALANCE
    ELSE NULL
    END)
    FROM SECURITY, ACCOUNT
    WHERE USER_ID = USER
    AND (CASE WHEN AUTHORITY > REQ_AUTHORITY THEN
BALANCE
        ELSE NULL
        END) > 100,000
```

The query may now be further optimized in accordance with the present invention by testing for mutually exclusive predicates in the CASE expression. In the above security view example, S12, BALANCE, and NULL are mutually exclusive because the values of BALANCE are defined as NOT NULL by a column option in the preceding CREATE TABLE ACCOUNT statement, S11. Next, the query optimization process evaluates the SELECT query, S13, for a predicate that matches (i.e. comprises or subsumes) one of the mutually exclusive return values for the CASE expression. In the above example, the BALANCE range in the CASE expression in the WHERE clause is matched with the BALANCE>100,000 predicate in the same WHERE clause. The query optimization process may then rewrite the query by removing remaining mutually exclusive CASE expression predicates while maintaining the matched predicate to produce the following optimized query 108:

```
SELECT ACCT_NO, OWNER, BALANCE S15
    FROM SECURITY, ACCOUNT
    WHERE USER_ID = USER
    AND AUTHORITY > REQ_AUTHORITY
    AND BALANCE > 100,000
```

As with the original query 106, this optimized query 108 returns results only to users who have sufficient authority to view all accounts having a balance greater than 100,000, and if there are no such accounts, or the user does not have the required authority, then nothing is returned.

Advantageously, by enabling the predicate BALANCE>100,000 to be applied directly to the base table, the column BALANCE may now be employed to further improve processing efficiency. By mapping predicates from the CASE expression to a predicate that can be applied directly to the base table, the mapped predicate may be available for use as a start or stop key for an index scan, if such an index exists. Otherwise, it is available for more direct application to the table, enabling faster, more efficient processing of the query 106.

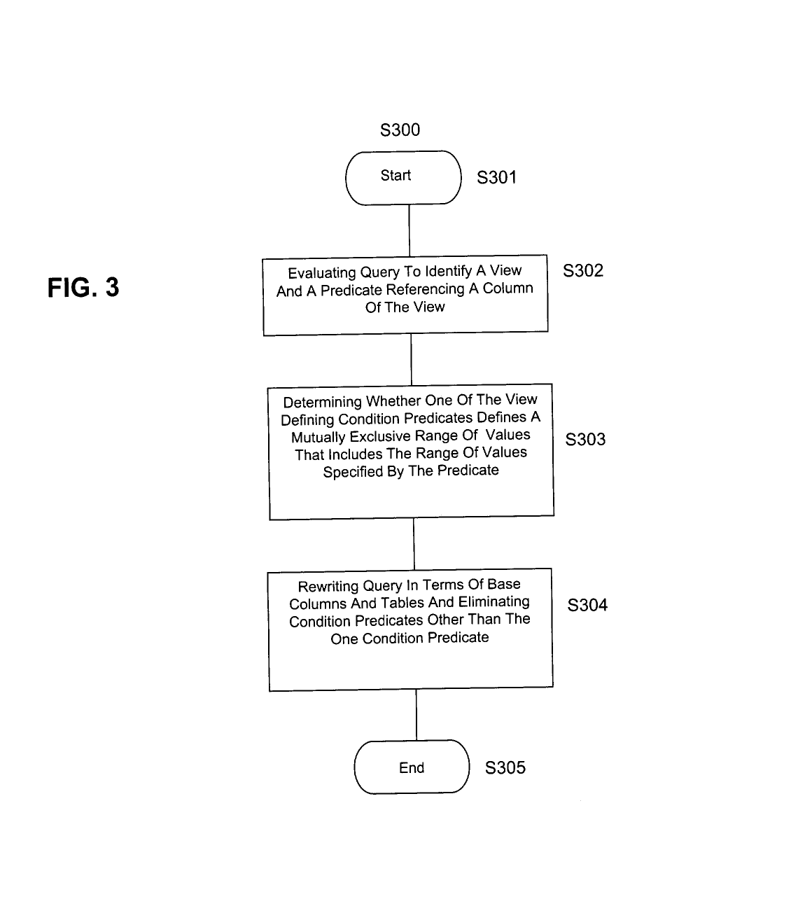

FIG. 3 is a flow chart illustrating the method S300 of a query optimization process for optimizing a query 106 on a view defined by a conditional expression in accordance with an embodiment of the invention. Referring to FIG. 3, the method of the present invention may be described in more general terms as follows:

At step S301, the operations S300 start.

At step S302, the query 106 (e.g. SELECT ACCT_NO, OWNER, BALANCE FROM SECURE_ACCOUNT WHERE BALANCE>100,000) is evaluated to identify a view (e.g. SECURE_ACCOUNT) and a predicate (e.g. BALANCE>100,000) referencing a column (e.g. BALANCE) of the view. The query 106 has a selection list (e.g. ACCT_NO, OWNER, BALANCE) specifying one or more columns of the view. The view is derived from one or more base tables (e.g. SECURITY, ACCOUNT). The predicate defines a first range of values of the column (e.g. >100,000). The values of the column are selected by a conditional expression (e.g. CASE WHEN . . . ). The conditional expression has condition predicates (e.g. AUTHORITY>REQ_AUTHORITY) for determining respective mutually exclusive ranges of the values (e.g. BALANCE NOT NULL, NULL). The condition predicates reference one or more base columns (e.g. AUTHORITY, REQ_AUTHORITY) of the base tables. The term mutually exclusive ranges refers to ranges that do not overlap.

At step S303, a determination is made as to whether one of the condition predicates (e.g. AUTHORITY>REQ_AUTHORITY) provides a mutually exclusive range of the values (e.g. BALANCE NOT NULL) that comprise (i.e. subsume) the first range of the values (e.g. BALANCE>100,000).

At step S304, in response to the steps of evaluating S302 and determining S303, the query 106 is rewritten in terms of the base columns and base tables. In this rewriting, the one condition predicate (e.g. AUTHORITY>REQ_AUTHORITY) that provides a mutually exclusive range of values (e.g. BALANCE NOT NULL) that comprises the first range of the values (e.g. BALANCE>100,000) is retained while the remaining condition predicates are eliminated.

At step S305, the operations end. In this manner, the predicate is applied directly to the base tables (e.g. SELECT ACCT_NO, OWNER, BALANCE FROM SECURITY, ACCOUNT WHERE USER_ID=USER AND AUTHORITY>REQ_AUTHORITY AND BALANCE>100,000) without the evaluation of the CASE expression and hence an optimized query 108 is produced.

While FIG. 3 illustrates the optimization of a query 106 on a view that is derived from base tables using CASE expressions, the operations may be readily configured to optimize queries on views that are derived from other views or that are derived using other conditional expressions (e.g. IF THEN ELSE, etc.) as may be apparent to those persons of ordinary skill in the art.

In addition to workgroup applications, the present invention may be applied to any column-level security or other application in which complex CASE expressions having mutually exclusive predicates are used to define columns in views and where these columns are then used in predicates of queries applied to those views. In particular, the foregoing description is exemplary only and the method of the present invention may be incorporated in any DBMS that employs a query optimization process.

While this invention is primarily discussed as a method, a person of ordinary skill in the art understands that the apparatus discussed above with reference to a computer-implemented database processing system may be programmed or configured to enable the practice of the method of the invention. Moreover, an article of manufacture for use with a data processing system, such as a pre-recorded storage device or other similar computer readable medium comprising program instructions recorded thereon may direct the data processing system to facilitate the practice of the method of the invention. It is understood that such apparatus and articles of manufacture also come within the scope of the invention.

It is to be understood that the specific embodiments of the invention that have been described are merely illustrative of certain application of the principle of the present invention. Numerous modifications may be made to the system and method for optimizing queries on views defined by conditional expressions having mutually exclusive conditions invention described herein without departing from the spirit and scope of the present invention.

What is claimed is:

1. An information retrieval method for optimizing a query, comprising:
evaluating the query to identify a view and a predicate referencing a column of the view;
wherein the view is derived from one or more base tables;
wherein the column comprises values selected by a conditional expression having condition predicates that define respective mutually exclusive ranges of the values;
wherein the condition predicates reference one or more base columns of the base tables;
wherein the predicate define a first range of the values of the column;
determining whether one of the condition predicates defines a mutually exclusive range of the values that comprises the first range of the values; and
rewriting the query to eliminate the condition predicates other than the one of the condition predicates and to apply the predicate directly to the base tables without evaluating the conditional expression.

2. The method of claim 1 wherein the conditional expression is a CASE expression.

3. The method of claim 1 wherein the conditional expression is an IF THEN ELSE expression.

4. The method of claim 1 wherein the base tables are views.

5. The method of claim 1 wherein the view is a security view restricting users from viewing selected columns of the base tables.

6. The method of claim 1 wherein the view comprises a set of tuples.

7. A query optimizer system for use in an information retrieval system that to optimize a query, the query optimizer system comprising:
a query evaluator for the query to:
(a) identify a view and a predicate referencing a column of the view; wherein the view is derived from one or more base tables; wherein the column comprise values selected by a conditional expression having condition predicates defining respective mutually exclusive ranges of the values; wherein the condition predicates reference one or more base columns of the base tables; and wherein the predicate define a first range of the values of the column; and
(b) determine whether one of the condition predicates defines a mutually exclusive range of the values that comprises the first range of the values; and
a query rewriter for the query to rewrite the query to eliminate the condition predicates other than the one of the condition predicates and to apply the predicate directly to the base tables without evaluating the conditional expression in response to the query evaluator.

8. The query optimizer system of claim 7 wherein the conditional expression is a CASE expression.

9. The query optimizer system of claim 7 wherein the conditional expression is an IF THEN ELSE expression.

10. The query optimizer system of claim 7 wherein the base tables are views.

11. The query optimizer system of claim 7 wherein the view is a security view restricting users from viewing selected columns of the base tables.

12. The query optimizer system of claim 7 wherein the view is a set of tuples.

13. A computer program product having instruction codes for directing an information retrieval system to optimize a query, the computer program product comprising:
a first set of instruction codes for evaluating the query to identify a view and a predicate referencing a column of the view; wherein the view is derived from one or more base tables; wherein the column comprises values selected by a conditional expression having condition predicates that define respective mutually exclusive ranges of the values; wherein the condition predicates reference one or more base columns of the base tables; and wherein the predicate defines a first range of the values of the column;
a second set of instruction codes for determining whether one of the condition predicates defines a mutually exclusive range of the values that comprises the first range of the values; and
a third set of instruction codes for rewriting the query to eliminate the condition predicates other than the one of the condition predicates and to apply the predicate directly to the base tables without evaluating the conditional expression.

14. The computer program product of claim 13 wherein the conditional expression is a CASE expression.

15. The computer program product of claim 13 wherein the conditional expression is an IF THEN ELSE expression.

16. The computer program product of claim 13 wherein the base tables are views.

17. The computer program product of claim 13 wherein the view is a security view restricting users from viewing selected columns of the base tables.

18. The computer program product of claim 13 wherein the view is a set of tuples.

19. An article for directing an information retrieval system to optimize a query, comprising:
means for evaluating the query to identify a view and a predicate referencing a column of the view; wherein the view is derived from one or more base tables; wherein the column comprises values selected by a conditional expression having condition predicates that define respective mutually exclusive ranges of the values; wherein the condition predicates reference one or more base columns of the base tables; and wherein the predicate defines a first range of the values of the column;
means for determining whether one of the condition predicates defines a mutually exclusive range of the values that comprises the first range of the values; and
means for rewriting the query to eliminate the condition predicates other than the one of the condition predicates and to apply the predicate directly to the base tables without evaluating the conditional expression.

20. The article of claim 19 wherein the conditional expression is a CASE expression.

21. The article of claim 19 wherein the conditional expression is an IF THEN ELSE expression.

22. The article of claim 19 wherein the base tables are views.

23. The article of claim 19 wherein the view is a security view restricting users from viewing selected columns of the base tables.

24. The article of claim 19 wherein the view is a set of tuples.

25. An information retrieval method for optimizing a query, comprising:
evaluating the query to identify a view and a predicate that references a column of the view;
deriving the view from one or more base tables;
the column comprising values selected by a conditional expression having condition predicates that define respective mutually exclusive ranges of the values;
the condition predicates referencing one or more base columns of the base tables; and
the predicate defining a first range of the values of the column.

26. An information retrieval system for optimizing a query, comprising:
means for evaluating the query to identify a view and a predicate that reference a column of the view;
the view being derived from one or more base tables;
the column comprising values selected by a conditional expression having condition predicates that define respective mutually exclusive ranges of the values;
the condition predicates referencing one or more base columns of the base tables; and
the predicate defining a first range of the values of the column.

27. A computer program product having instruction codes for directing an information retrieval system to optimize a query, the computer program product comprising:
a first set of codes for evaluating the query. to identify a view and a predicate that reference a column of the view;
the view being derived from one or more base tables;
the column comprising values selected by a conditional expression having condition predicates that define respective mutually exclusive ranges of the values;
the condition predicates referencing one or more base columns of the base tables; and
the predicate defining a first range of the values of the column.
